(19) United States
(12) Patent Application Publication
(10) Pub. No.: US 2025/0243843 A1
(43) Pub. Date: Jul. 31, 2025

(54) WIND-DRIVEN ENERGY APPARATUSES AND METHODS THEREOF

(71) Applicant: Regents of the University of Minnesota, Minneapolis, MN (US)

(72) Inventors: Yash Dagade, Minneapolis, MN (US); Sayan biswas, Minneapolis, MN (US)

(21) Appl. No.: 19/041,455

(22) Filed: Jan. 30, 2025

Related U.S. Application Data
(63) Continuation of application No. 63/626,710, filed on Jan. 30, 2024.

(51) Int. Cl. F03D 5/00

(52) U.S. Cl. CPC F03D 5/015; F05B 2240/211; F05B 2240/921; F05B 2280/5006

(57) ABSTRACT

The present document relates to an airborne wind-driven energy-converting apparatus, as well as wind-driven energy systems including such an apparatus and methods of producing wind-driven energy.

### CLAIM OF PRIORITY

This application claims priority under 35 USC § 119 (e) to U.S. Patent Application Ser. No. 63/626,710, filed on Jan. 30, 2024, the entire contents of which are hereby incorporated by reference.

### BACKGROUND

Airborne wind energy systems (AWEs) convert wind power into electrical power while being suspended in air.

### SUMMARY

Conventional AWEs operate within limited altitudes and can be inefficient in converting wind power to electrical power due to the design of the AWEs and the energy required to operate the AWEs. Without being limited to any theory, in general, available wind power increases with increasing altitude, and wind power can be more stable at higher altitudes. The present disclosure provides A WEs that can operate in a relatively large range of altitudes, e.g., between about 300 feet to about 30,000 feet, and that have aerodynamic designs that lead to higher efficiencies of energy conversion.

In a first aspect, the present document encompasses an airborne wind-driven energy-converting apparatus including: a flotation module including a lighter-than-air (LTA) shell configured to provide an inner volume and a bed region disposed beneath the LTA shell; a stability module configured to control drift and/or elevation of the unit, an energy module including a plurality of energy cells, a tethered power transfer module electrically connected to an energy storage unit and optionally to a transmission grid connected to the energy storage unit; and a ground control module equipped with sensors (e.g., power meter, communication system, weather station, GPS, load cell, tension sensors, accelerometers, gyroscopes, etc.). The stability module can be disposed on a surface of the flotation module. At least one energy cell can include a vertical axis wind turbine. At least one energy cell can include an angled axis wind turbine. At least one energy cell can include an angled axis wind turbine.

In another aspect, the present document encompasses a wind-driven energy system including: one or more airborne wind-driven energy-producing apparatuses, e.g., as disclosed herein; and a ground station configured to communicate with and form a tether with at least one of the one or more airborne wind-driven energy-producing apparatuses.

In yet another aspect, the present document encompasses a method of producing wind-driven energy, the method including: varying an elevation of one or more airborne wind-driven energy-producing apparatuses configured to operate at an elevation between about 300 feet to about 30,000 feet; and generating energy (e.g., from about 1 kW to 1 MW) from at least one of the one or more airborne wind-driven energy-producing apparatuses.

The foregoing and other embodiments can each optionally include one or more of the following features, alone or in combination.

In some implementations, the LTA shell includes a hydrophobic material, an elastic material, a shape memory alloy, and/or a composite material (e.g., a carbon fiber composite).

In some implementations, the LTA shell includes a composite material disposed on an outer surface of the shell.

In some implementations, the LTA shell includes a hydrophobic material disposed on an inner surface of the shell.

In some implementations, the inner volume of the LTA shell includes a lighter-than air gas (e.g., helium, hydrogen, heated air, or a combination thereof).

In some implementations, the airborne wind-driven energy-converting apparatus includes one or more components selected from the group consisting of a heater, a processor, an inertial measure unit, a navigation system, a positioning system, a control system (e.g., an artificial intelligence-driven control system), a sensor, a power source, a radar, and an anticollision light.

In some implementations, at least one component is disposed on a surface of the bed region.

In some implementations, the at least one component is disposed within the internal volume of the LTA shell.

In some implementations, the airborne wind-driven energy-converting apparatus includes a heater disposed within the internal volume of the LTA shell. The heater can be configured to heat a gas within the internal volume (e.g., thereby increasing an elevation of the unit).

In some implementations, the heater is configured to transmit and/or receive information from one or more of a processor, an inertial measure unit, a navigation system, a positioning system, a control hub, a sensor, a power source, or a radar (e.g., disposed on a surface of the bed region).

In some implementations, the stability module includes one or more components (e.g., a passive component or an adjustable component) configured to control the drift and/or the elevation.

In some implementations, the one or more components is selected from the group consisting of a lift wing, a bridle, a tether, a fan (e.g., a crossflow fan), a direction vane, a rudder, and a combination of any of these.

In some implementations, at least one component includes a lift wing.

In some implementations, the lift wing is on a surface of the LTA shell and/or a surface of the bed region.

In some implementations, at least one component includes a bridle.

In some implementations, at least one component includes a tether.

In some implementations, the vertical axis wind turbine includes a Darrieus-type rotor wind turbine, an H-Darrieus-type wind turbine, a Savonius-type wind turbine, or a revolving wing wind turbine. In some implementations, the angled axis wind turbine includes a Darrieus-type rotor wind turbine, an H-Darrieus-type wind turbine, a Savonius-type wind turbine, or a revolving wing wind turbine.

In some implementations, the angled axis wind turbine includes a central rotating shaft. Each of a plurality of blades can be attached to the central rotating shaft by a respective arm; or the angled axis wind turbine can include a frame including a central rotating shaft connected to each of a plurality of blades by a respective arm. In some implementations, the angled axis wind turbine includes a central rotating shaft. Each of a plurality of blades can be attached to the central rotating shaft by a respective arm; or the angled axis wind turbine can include a frame including a central rotating shaft connected to each of a plurality of blades by a respective arm.

In some implementations, at least one of the plurality of blades includes an airfoil, a symmetrical airfoil, or a non-symmetrical airfoil.

In some implementations, the vertical axis wind turbine includes a plurality of blades extending from the central rotating shaft. In some implementations, the angled axis wind turbine includes a plurality of blades extending from the central rotating shaft.

In some implementations, the plurality of energy cells includes an even number of energy cells.

In some implementations, a pair of energy cells of the plurality of energy cells includes a pair of counter rotating energy cells (e.g., in which a first energy cell is configured to rotate in a clock-wise direction and a second energy is configured to rotate in a counter clock-wise direction).

In some implementations, the at least one energy cell includes a diffuser wall configured to direct and/or block air to the vertical axis wind turbine. In some implementations, the at least one energy cell includes a diffuser wall configured to direct and/or block air to the angled axis wind turbine.

In some implementations, the at least one energy cell includes a guide vane configured to direct and/or block air to the vertical axis wind turbine. In some implementations, the at least one energy cell includes a guide vane configured to direct and/or block air to the angled axis wind turbine.

In some implementations, the energy module further includes one or more generators configured to rotate the plurality of energy cells.

In some implementations, the apparatus is configured to operate at an elevation between about 5,000 feet to about 30,000 feet.

In some implementations, the tethered power transfer module is attached to the ground control module.

In some implementations, a tether is configured to transmit and/or receive power or energy between the at least one airborne wind-driven energy-producing apparatus.

In some implementations, the tether is configured to transmit and/or receive information between the at least one airborne wind-driven energy-producing apparatus.

In some implementations, the ground station includes a motor configured to extend or retract the tether between the ground station and the at least one airborne wind-driven energy-producing apparatus.

In some implementations, the ground station includes an energy storage unit (e.g., configured to store energy produced by the at least one airborne wind-driven energy-producing apparatus).

In some implementations, the ground station includes one or more of the following: a processor (e.g., configured to receive and transmit information, such as weather information, between the ground station and the at least one airborne wind-driven energy-producing apparatus), a power meter, a communication system, a weather station, GPS, a load cell, a tension sensor, an accelerometer, a gyroscope, or a combination of any of these.

In some implementations, said varying includes: transmitting information (e.g., weather information and the like) to the at least one airborne wind-driven energy-producing apparatus; and ascending or descending the at least one airborne wind-driven energy-producing apparatus based on said information.

In some implementations, said ascending or descending includes retracting or advancing a tether attached to the at least one airborne wind-driven energy-producing apparatus.

In some implementations, said ascending or descending includes heating or cooling air within a flotation module of the at least one airborne wind-driven energy-producing apparatus.

In some implementations, the method includes transferring the energy to an energy storage device or an energy storage unit. In some embodiments, the energy storage device is located in proximity to the LTA shell. In some embodiments, the energy storage unit is located on the ground.

In some implementations, the at least one airborne wind-driven energy-producing apparatus includes an apparatus, e.g., as disclosed herein, or a system, e.g., as disclosed herein.

The subject matter described in this specification can be implemented in various embodiments and may result in one or more of the following advantages. In some implementations, for example, a single energy producing apparatus can convert wind power to electrical power at a cost of $25/MWhr Levelized Cost of Electricity (LCOE), which is 25% greater than conventional AWEs.

Due to the design of the energy producing apparatus, the apparatus can be robust to adverse weather, such as storms and intense wind. Since the energy producing apparatus is airborne, systems of multiple energy producing apparatuses can leave little on the ground. In some implementations, the materials used to create individual energy producing apparatuses and the system are relatively affordable and eco-friendly, e.g., non-toxic.

The disclosed energy producing apparatuses and systems have various applications, such as offshore wind harnessing, power generation in remote locations, and additional power sources in urban areas.

In some implementations, the system is scalable, e.g., multiple AWEs can be used in clusters to produce power ranging from a few kW to MW. In some implementations, the system requires relatively little maintenance, e.g., compared to other AWEs, there can be fewer parts that are durable, making it less complicated to assemble and operate.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is depicts an energy-converting apparatus, e.g., a flying energy generator (FEG) that converts wind energy to electrical energy.

FIG. 1B depicts an energy-converting apparatus in more detail.

FIG. 1C depicts an energy farm including multiple energy-converting apparatuses.

FIG. 1D depicts an example of an energy farm including multiple energy-converting apparatuses attached by way of tether/bridle lines and power transfer lines to a ground control module.

FIG. 2 depicts a plot of simulated probability densities of wind having a particular speed for two different altitudes.

FIG. 3 depicts a graph of the energy density for systems using horizontal axis wind turbines (HAWTs) and vertical axis wind turbines (VAWTs).

FIG. 4 is a plot of the ratio of the coefficient of power to the tip speed ratio as a function of the tip speed ratio.

FIG. 5A depicts a layout in a computational simulation for AWEs.

FIG. 5B depicts a plan view of an arrangement of turbines and diffuser walls, and FIG. 5C depicts a perspective view of the arrangement of FIG. 5B of the turbines and the diffuser walls.

FIG. 5D depicts a plan view of an example of a single wind turbine.

FIG. 6 depicts a simulation based on a sliding mesh model capturing the unsteady flow dynamics induced by the rotating turbine blades.

FIG. 7 depicts a plot of simulation results for the power coefficients for different tip speed ratios.

FIG. 8 depicts a velocity contour plot for wind as it moves to the arrangement of turbines and diffusers.

FIG. 9 is a plot of the coefficients of power for the four turbines as a function of the tip speed ratio.

FIG. 10 is a plot the coefficient of power versus the tip to speed ratio for the arrangement of turbines and a single turbine.

FIGS. 11A and 11B respectively depict perspective and plan views of a computational domain set up for dynamic stability analysis.

FIG. 12 depicts a plot capturing the rate at which an energy-converting apparatus re-orients itself to a new incoming wind direction.

FIG. 13 depicts an energy-converting device with a center of pressure directly below a center of mass.

FIG. 14 depicts a plot of the lift force as a function of angle of attack.

FIG. 15 is a plot demonstrating that the wing angle of attack is a function of wind speed that results in a constant lift force.

FIG. 16A depicts a view of the bottom of an energy-converting apparatus. FIG. 16B depicts a view of the top of the energy-converting apparatus of FIG. 16A.

FIG. 16C depicts a side view of an energy-converting apparatus.

FIG. 16D depicts elements of an energy-converting apparatus and related features of the elements.

FIGS. 17A and 17B depict two pairs of turbines and guide vanes.

FIGS. 18A and 18B depicts two series and series of iterations that can improve each of the wings of the turbine and guide vanes.

FIGS. 19A and 19B depict iterations that can improve the organization of an AWE farm.

FIG. 20 depicts a plot of the power factor versus the number of energy cells.

FIG. 21 depicts an AWE with a streamlined balloon shape overlaid on a contour plot of the wind velocity around the AWE.

FIG. 22A depicts a plot of flow trajectories of air particles through an AWE farm.

FIGS. 22B and 22C depict contour plots of flow trajectories through an AWE farm.

FIG. 23 depicts a velocity isosurface of an AWE.

FIG. 24 depicts a plot of the average power with respect to time (normalized scale) from a single “Energy Cell” unit.

FIG. 25 depicts the flow trajectories of a lift blade.

FIG. 26A depicts design parameters of guide vanes with different numbers of guide vanes.

FIG. 26B depicts geometrical design parameters of guide vanes.

FIG. 27 depicts tables with parameters from testing wind tunnels for different geometries. Like reference numbers and designations in the various drawings indicate like elements.

### DETAILED DESCRIPTION

The present document relates to an airborne wind-driven energy-converting apparatus, as well as systems including one or more such apparatuses. Also described herein are method for producing wind-driven energy. In some embodiments, the apparatus includes one or more energy cells, which can be scaled and configured to any useful range of energy output (e.g., from a few kW to a MW). In some non-limiting instances, the energy cell includes an angled, e.g., angled relative to the horizontal axis, axis wind turbine, e.g., a vertical axis wind turbine (VAWT). As described herein, a plurality of VAWTs can be provided in any useful cluster configuration.

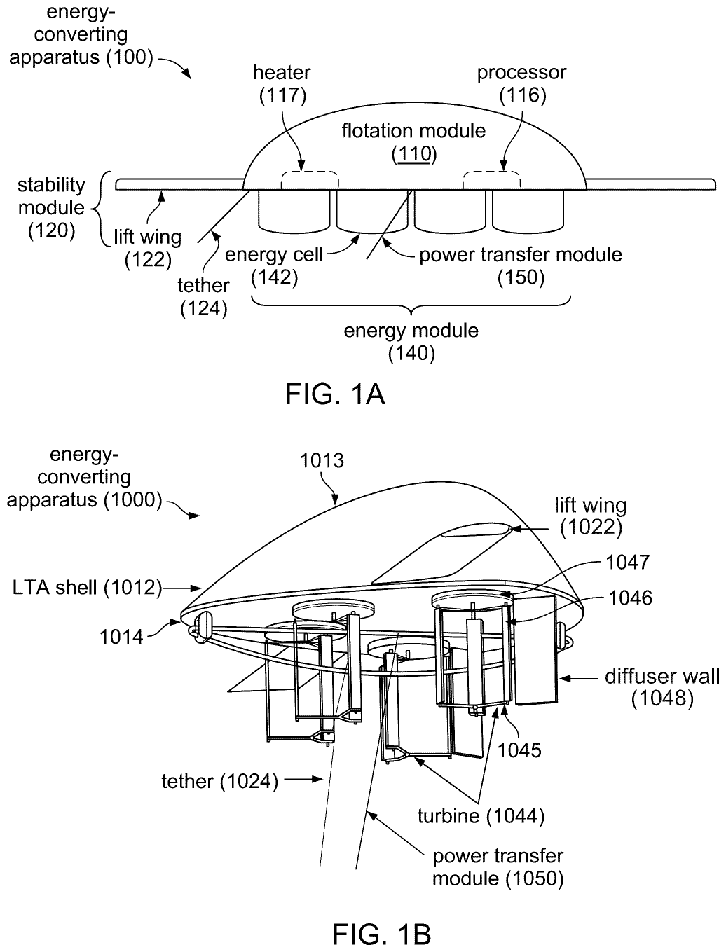

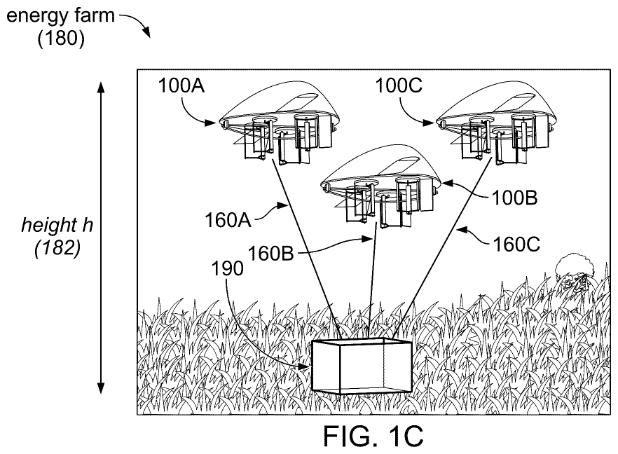

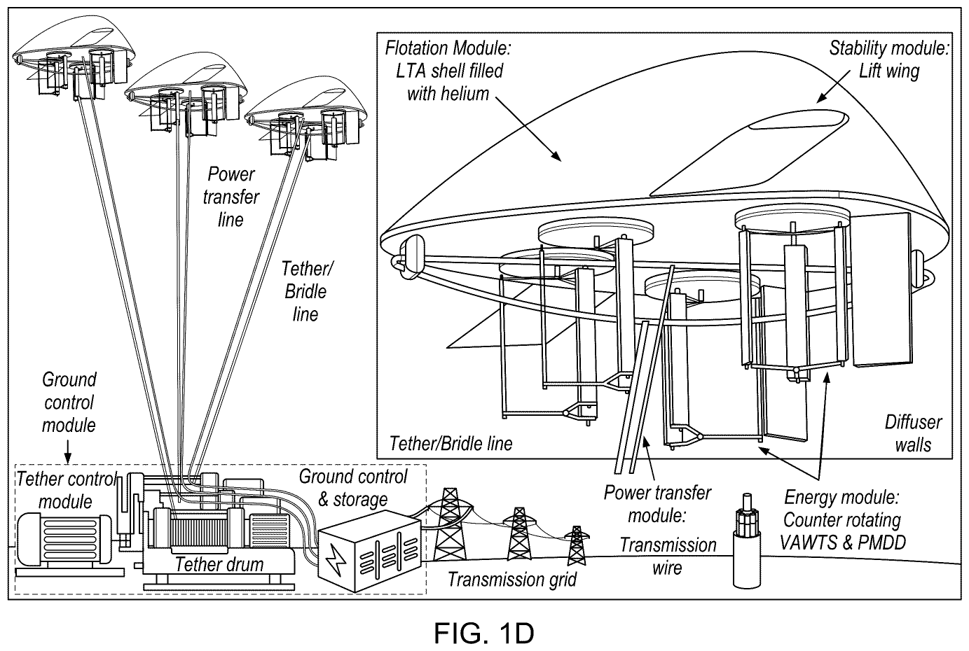

FIG. 1A depicts an energy-converting apparatus 100, e.g., a flying energy generator (FEG) that converts wind energy to electrical energy. The energy-converting apparatus 100 includes a flotation module 110, a stability module 120, and an energy module 140. The design and operation of the flotation module 110 allow the energy-converting apparatus 100 to float in air. For example, the flotation module 110 includes a heater 117 that can heat gases within the flotation module 110, thereby reducing the density of the gases and creating a buoyant force that lifts the energy-converting apparatus 100. By turning off the heater 117, the gases within the flotation module 110 can passively cool. The heater 117 is disposed within an internal volume of the flotation module 110. A processor 116 can be configured to control the heater 117 as well as other elements.

The stability module 120 controls drift, elevation, or both of the energy-converting apparatus 100. The stability module 120 includes lift wings 122 that connect to the surface of the flotation module 110. The lift wings 122 are connected at the bottom of the flotation module 110, the bottom of the lift wings 122 being roughly in the same plane as the bed of the flotation module 110. As will be described later in more detail, the lift wings 122 can be passive or adjustable components. The stability module may optionally include one or more fans (e.g., crossflow fans), lift wings, direction vanes, rudders, and the like.

The stability module 120 includes a tether 124, which keeps the energy-converting apparatus 100 stably connected to a ground module. In some implementations, the tether 124 can be used in combination with a power transfer module 150 connected to an energy storage unit and/or grid on the ground. The tether 124 and/or the power transfer module 150 can transmit and/or receive energy, information, or both between the energy-converting apparatus 100 and a ground module.

The energy module 140 includes energy cells 142 disposed on the bed of the flotation module 110. FIG. 1B depicts an energy-converting apparatus 1000 in more detail. For example, each energy cell includes a turbine 1044, which includes a frame 1045, blades 1046, and an energy storage device 1047. Each frame 1045 includes a central rotating shaft connected to each blade 1046 by a respective arm. Alternatively, the energy cell can include a central rotating shaft, in which each of a plurality of blades is attached to the central rotating shaft by a respective arm. Rotation can be achieved through the pressure differential over the blade surface.

The turbines 1044 rotate about an angled axis, e.g., a vertical axis, going through the center of each frame 1045. In this example, there are three blades 1046 equally spaced around the vertical axis, which rotate when the energy-converting apparatus 1000 encounters wind. For example, the vertical axis can be defined as parallel to gravity or normal to the plane of the lift wing. Rotation of the turbines 1044 converts wind energy to electrical energy, which is stored in the energy storage device 1047, cause an upward force on the energy-converting apparatus 1000, or both.

In some implementations, the turbines 1044 include a Darrieus-type rotor wind turbine, an H-Darrieus-type wind turbine, a Savonius-type wind turbineor a revolving wing wind turbine. Darrieus wind turbines are VAWTs with curved aerofoil blades. In some implementations, the turbines 1044 do not include a gearbox, unlike HAWTs, which generally include a gearbox. For example, in a typical HAWT, a gearbox between the blades and shaft increases the allowable speed of rotation of the wind turbine, e.g., the blades rotate relatively slowly, and the shaft inside the turbine nacelle connected to a motor rotates relatively quickly. Blades in a VAWT can generally rotate at higher speeds compared to HAWTs, so a gearbox is not necessary.

The blades 1046 can include a light weight and durable fabric with a twisted shape that encourages lift. For example, the fabric can include nylon, spandex, and other synthetic polymers. The twisted shape refers to the curve in the outline of the blades 1046 when seen from a plan view. For example, the angle between an edge portion of the blade connected to the central shaft and a line from the central shaft to the opposite edge portion of the blade can be 12°. In some implementations, each blade 1046 ways a kilogram or less. As a result, the blade 1046 can behave like an airfoil, e.g., a symmetric airfoil or asymmetric airfoil.

In some implementations, the turbines 1044 are arranged to prevent undesired angular rotation of the energy-converting apparatus 1000. For example, if all of the turbines 1044 rotated in the same direction, e.g., clockwise, the energy-converting apparatus 1000 can have a nonzero angular momentum, and consequently rotate. However, an even number of turbines 1044 can be arranged and designed, such that half of the turbines rotate clockwise and the other half rotate counterclockwise. The direction of rotation can be determined by the shape and orientation of the blades 1046.

In some implementations, the arrangement of the energy cells 142 can impact the efficiency of the energy-converting apparatus 100. For example, the energy cells 142 can be arranged to reduce drag experienced by the entire system.

The energy storage device 1047 is connected to the bed 1014, e.g., a lower surface, of the flotation module. The energy module 140 includes one or more diffuser walls 1048, which can direct and/or block air to the angled axis of the turbines 1044. In this specification, a diffuser wall can also be referred to as a guide. Similarly to a diffuser wall, guide vanes can channel wind toward the turbines, which can lead to higher incoming wind velocities and consequently higher power output and overall efficiency of energy conversion. For example, multiple guide vanes arranged around the bed 1014 can create a vortex within the energy module 140.

Rotation of the turbines 1044 can lift or lower the energy-converting apparatus 1000. The flotation module 110 being lightweight and aerodynamic, e.g., experiencing little drag, can reduce how much work the turbines due to lifts the energy-converting apparatus 1000. For example, the flotation module 110 includes a lighter-than-air (LTA) shell 1012, e.g., the total weight of the LTA shell 1012 is less than the weight of an equal volume of air. The LTA shell 1012 can include an inner volume filled with a gas such as hydrogen, helium, heated air, or a combination thereof, which is less dense than ambient air. In some implementations, 120 m³ of helium can support one energy-converting apparatus 1000. The surface 1013 of the LTA shell 1012 can include a hydrophobic fabric, carbon fibers, and elastic material, or a combination thereof (a composite material), so that the LTA shell 1012 will not absorb water during inclement weather. The carbon fibers provide a high strength fabric, which has a low risk of damage during use. In some implementations, the outer surface (which is visible in FIG. 1B) of the surface 1013 of the LTA shell includes a composite material. In some implementations, the inner surface of the surface 1013 of the LTA shell 1012 includes a hydrophobic material.

In some implementations, the energy storage units 1047 include generators, which can cause the turbines 1044 to rotate even when there little to no wind. For example, the generators can cause the turbines 1044 to rotate in both directions to cause the energy-converting apparatus 1000 to gain or lose elevation, e.g., perform altitude control. For example, when an energy-converting apparatus 1000 is ascending from the ground to the air, e.g., the “lift-off” phase, the heaters 117 heat the gas within the LTA shell 1012 to provide most of the upward force. The energy-converting apparatus 1000 can include a tether 1024 that is stably connected to a ground module. Once the desired altitude is reached and when velocities are high enough, the energy harvesting phase begins. During the energy harvesting phase, the blades 1046 of the turbine 1044 rotate more due to the power of wind rather than the power of generators. Harvested energy can be transmitted from the energy-converting apparatus 1000 by way of a power transfer module 1050. In some implementations, the power transfer module 1050 is attached to the ground control module 190.

In some implementations, the LTA shell 102 includes shape memory alloys that cause the LTA shell to contract or expand as the LTA shell 102 changes altitude based on a temperature gradient in the surrounding atmosphere. The incorporation of the shape memory alloys thus allows for passive control of the lift generated by the LTA shell 102.

FIG. 1C depicts an energy farm 180 including multiple energy-converting apparatuses 100A, 100B, and 100C. Each energy-converting apparatus, e.g., energy-converting apparatuses 100A, 100B, and 100C are connected to a ground control module 190 via respective tethers 160A, 160B, and 160C. The energy-converting apparatuses 100A-C can correspond to either energy-converting apparatus 100 or 1000, and the tethers 160A-C can correspond to tether 124 or 1024. The tethers 160A-C prevents the energy-converting apparatuses 100A-C from translating more than a threshold distance away from the ground control module 190.

The tethers 160A-C flexibly connect the energy-converting apparatuses 100A-C to the ground control module 190. For example, the energy-converting apparatuses 100A-C can move in three-dimensional space while still remaining tether to the ground control module 190. The tether 160A-C can be connected to the energy-converting apparatuses 100A-C with a rotational degree of freedom, such that the energy-converting apparatus 100 remains upright, e.g., the rotational axis of the turbines are vertically aligned, though the angle of the tether 160 relative to the axis changes.

In some implementations, the ground control module 190 includes a motor coupled to a respective tether 160, where operation of the motor advances or retracts the tether between the ground control module 190 and the energy-converting apparatus 100 For example, each of tethers 160A-C can have a length longer than h so that the energy-converting apparatuses 100A-C can reach a height h 182 above the ground on which the ground control module 190 is located. In some implementations, the ground control module 190 includes a directional control mechanism for the tether 160, e.g., to control the angle of the tethers 160 relative to the ground and the altitude. The angle of the tethers 160 can depend on the glide ratio, e.g., the ratio of the forces of lift and drag, which can be controlled by the lift wings 122 and the LTA shell 1012.

The ground control module 190 can be equipped with sensors, e.g., power meter, communication system, weather station, GPS, load cell, tension sensors, accelerometers, gyroscope. In some implementations, the ground control module 190 includes an energy storage unit, e.g., is configured to store energy produced by the energy-converting apparatus 100. In some implementations, the ground control module 190 includes a processor, e.g., is configured to receive and transmit information, such as weather information, between the ground control module 190 and the energy-converting apparatus 100.

FIG. 1D depicts another non-limiting energy farm including multiple energy-converting apparatuses attached by way of tether/bridle lines and power transfer lines to the ground control module. In turn, the ground control module can include a tether control motor configured to advance or retracts the tether between a tether drum and each energy-converting apparatus. Harvested energy can be transferred by way of power transfer lines from each energy-converting apparatus to ground storage, which in turn can be electrically connected to the transmission grid.

In some implementations, the energy-converting apparatus 100 does not include a tether. For example, the energy-converting apparatus 100 can include a battery that stores the electrical energy, which can be periodically replaced, e.g., by a drone. In some implementations, the period is one hour. Implementations lacking a tether can advantageously avoid drag and other sources of energy inefficiencies.

In some implementations, the energy-converting apparatus includes one or more of the following components: an inertial measurement unit, a navigation system, a positioning system, a control hub, various types of sensors, a power source, and a radar. For example, these components can be disposed on a surface of the bed region.

### EXAMPLES

### Example 1: A Continuous AWE

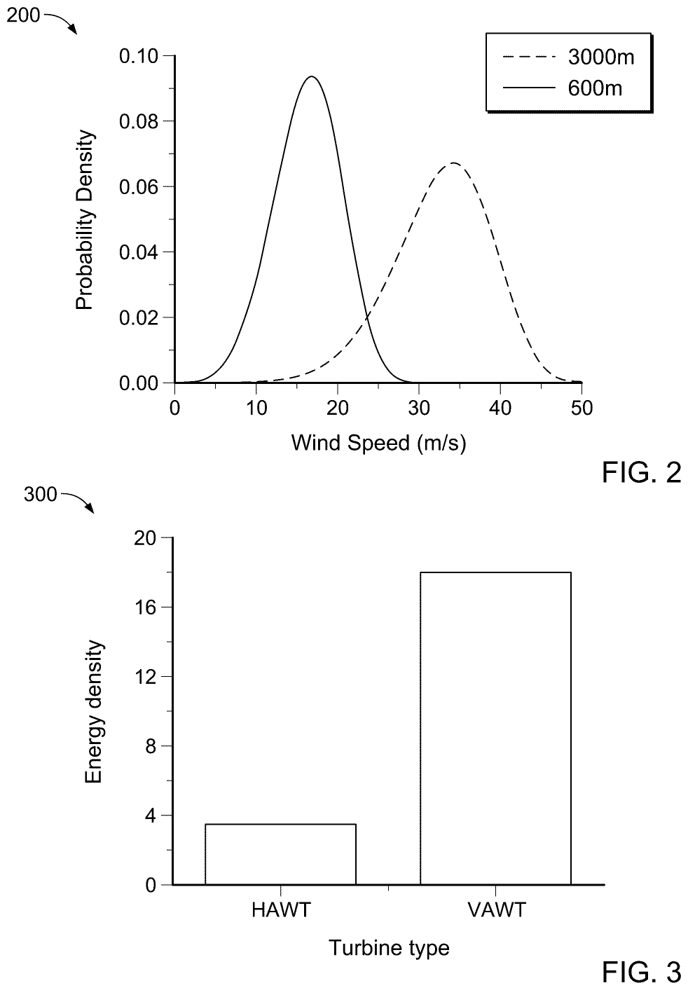

Without being limited to any particular theory, wind speeds are generally greater at higher altitudes. FIG. 2 depicts a plot 200 of simulated probability densities of wind having a particular speed for two different altitudes, e.g., 600 m and 3000 m. For example, the peak of the probability density for the 600 m distribution is about 15 m/s, and the peak of the probability density for the 3000 m distribution is about 35 m/s. Indeed, harnessing wind energy at higher altitudes, where wind speeds are greater, can present a more efficient approach compared to lower altitude operations. In some non-limiting embodiments, the apparatuses, systems, and methods herein are employed for higher altitudes (e.g., by targeting subtropical jet streams characterized by high wind speeds). Traditional AWE technologies, although airborne, are typically constrained to low-altitude operations.

Many AWEs utilize turbines, e.g., horizontal axis wind turbines (HAWT) or vertical axis wind turbines (VAWT) for converting wind energy into electrical energy. In some implementations, an individual VAWT can have a lower efficiency than an individual HAWT. However, clusters of VAWTs can have greater efficiencies than clusters of HAWTs. For example, FIG. 3 depicts a graph 300 of the energy density for systems using HAWTs or VAWTs. The energy density for the system using VAWTs is about four times greater than the energy density of the system using HAWTs.

Several factors contribute to the greater efficiencies of systems utilizing VAWTs compared to those using HAWTs. For example, VAWTs tend to be more stable and quieter than HAWTs, e.g., VAWTs have a greater coefficient of power Cₚ at lower tip-speed ratios (TSR, also referred to as λ), leading to a greater ratio (Cₚ/TSR), which can be important in high windspeed environments. Having a lower TSR relative to the Cₚ can also indicate lower chance of vortex induced vibrations, which can increase tether drag and therefore reduce efficiency. Note that both the coefficient of power Cₚ and TSR are unitless parameters.

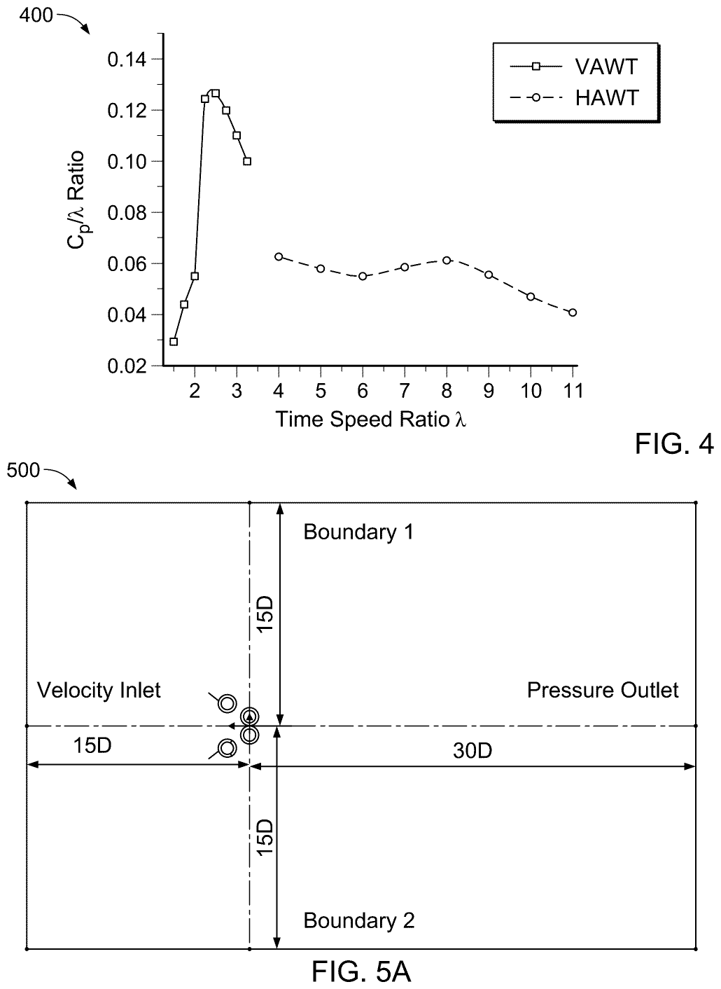

FIG. 4 is a plot 400 of the ratio of the coefficient of power Cₚ to the tip speed ratio TSR as a function of the tip speed ratio TSR, e.g., Cₚ/λ vs. λ. As depicted by FIG. 4, within the range of 1-11, the VAWT is able to achieve a higher ratio Cₚ/λ compared to HAWT. Further, these higher values of the ratio Cₚ/λ occur at lower tip to speed ratios TSR, which is favorable for energy efficiencies.

In some implementations, VAWTs can be more compatible with diffusers, e.g., diffusion walls 1048, and guide vanes compared to HAWTs, since the blades of a VAWTS can be approximately parallel to the diffusers and/or guide vanes. The combination of VAWTs and a diffuser can be referred to as a diffuser augmented wind turbine (DAWT).

In general, VAWTs can experience negative torque during the airfoil's return revolution. To mitigate this problem, in some implementations, the VAWT can be arranged to prevent wind from striking the turbine blades and negative angles, e.g., preventing wind that would cause the wind turbines to rotate in the opposite direction, while simultaneously accelerating wind that encounters blades at advantage angles.

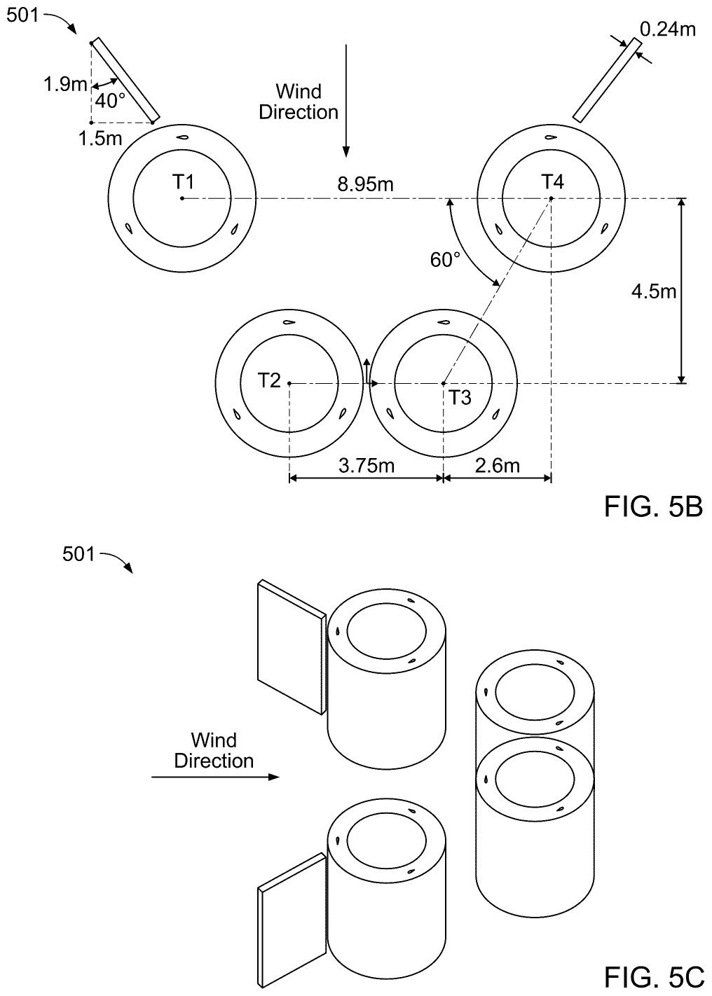

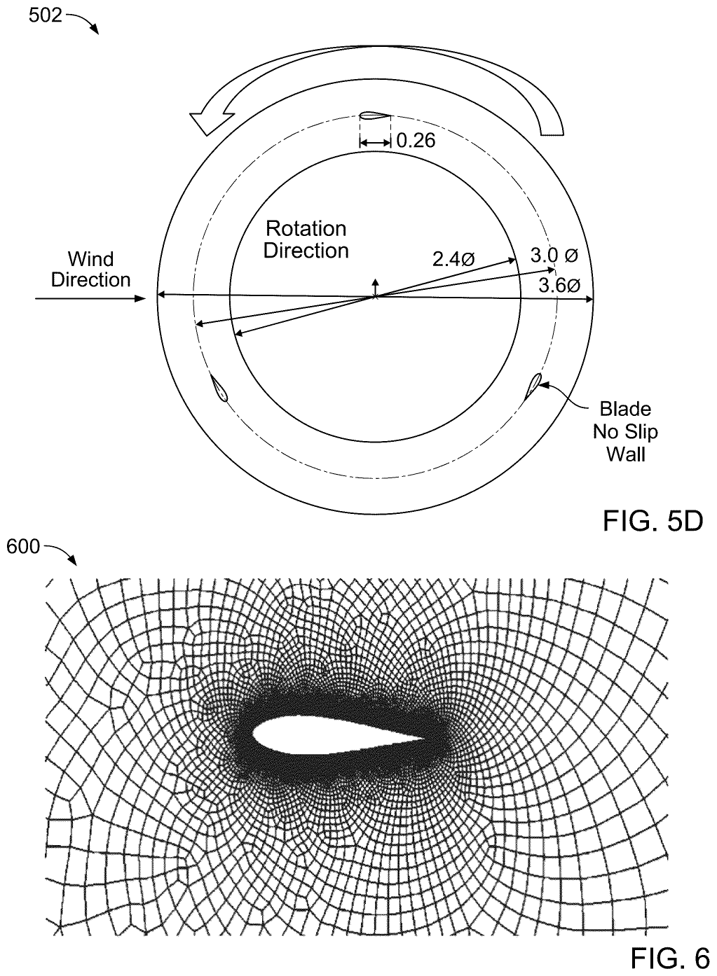

FIG. 5A depicts the layout 500, e.g., boundary conditions for the velocity inlet, pressure outlet, boundary 1, and boundary 2, in a computational simulation. Distances between different boundaries are indicated in units of the diameter of the wind turbine D. For example, the distance between boundary 1 and boundary 2 is 30D in the distance between the velocity inlet and the pressure outlet is 45D.

FIG. 5B depicts a plan view of an arrangement 501 of turbines and diffuser walls, and FIG. 5C depicts a perspective view of the arrangement 501 of the turbines and the diffuser walls. In this example, there are four wind turbines T1, T2, T3, and T4, arranged in a trapezoidal shape. The wind direction is along the vertical direction from the top of the trapezoid, e.g., the line connecting turbines T1 and T4, to the bottom of the trapezoid, e.g., the line connecting turbines T2 and T3. The centers of top turbines T1 and T4 are separated by 8.95 meters, the centers of bottom turbines T2 and T3 are separated by 3.75 m, and the height of the trapezoid, e.g., the vertical distance between the centers of turbines T3 and T4, is 4.5 m. The angle between the line connecting turbines T1 and T4 and the line connecting turbines T3 and T4 is 60°.

Diffuser walls D1 and D2 are arranged next to the top turbines T1 and T4. In some implementations, the diffuser walls D1 and D2 are disposed next to exterior turbines, e.g., turbines closer to the edge of the bed region. In this example, the turbines are 0.24 m thick and are symmetrically disposed at an angle of 40° relative to the vertical direction. Each diffuser D1 and D2 can span a horizontal length of 1.5 m in a vertical length of 1.9 m.

FIG. 5D depicts a single wind turbine 502, e.g., any of turbines T1-T4. In this example, the wind turbine 502 rotates in a counterclockwise direction. In this example, the turbine diameter is 3 m, indicated by 3.0>, and the rotating region is between 2.4 m to 3.6 m, indicated by 2.4> and 3.6>. The airfoil chord length for the turbine is 0.26 m. In simulations using computational fluid dynamics (CFD), no slip walls are assumed for the fluent solver.

FIG. 6 depicts a simulation 600 based on a sliding mesh model capturing the unsteady flow dynamics induced by the rotating turbine blades. Using a sliding mesh model can demonstrate that the CFD simulation results do not depend on the mesh, e.g., grid. In this example, Ansys meshing is used to generate a nonconforming mesh with unstructured quadrilateral elements. The matches refined near the airfoil services to account for the boundary layer, featuring 10 levels of quadrilateral elements with a maximum thickness of 2 mm and a growth rate of 1.1. The y+ value for the mesh falls within the range of 1 to 5, and the mesh consists of 3,057,836 elements.

Fluent code is employed to solve the unsteady Reynolds averaged Navier-Stokes equations using the finite volume method. The Semi-Implicit Method for Pressure-Linked Equations (SIMPLE) algorithm is utilized for the semi implicit method, with second-order spatial discretization for pressure, momentum, and turbulence equations. To capture the turbulence correctly, the SST k-ω turbulence model is adopted. The Reynolds number for the flow is approximately 6×10⁶, which is ideal for the selected turbulence model. Initially, a steady-flow simulation is conducted to establish reasonable parameters for the flow domain. This is followed by unsteady flow simulations using the Sliding Mesh Model. A time step size, corresponding to a turbine rotation of 1.0 degree, is used for the time-dependent solution. Convergence criteria include a drop of at least three orders of magnitude in residuals for each time step and a minimum of 20 iterations per time step. Both the present study and the referenced work operate within a Reynolds number range of 104 to 107, offering a suitable basis for validation. The simulation employed the k-ω SST turbulence model.

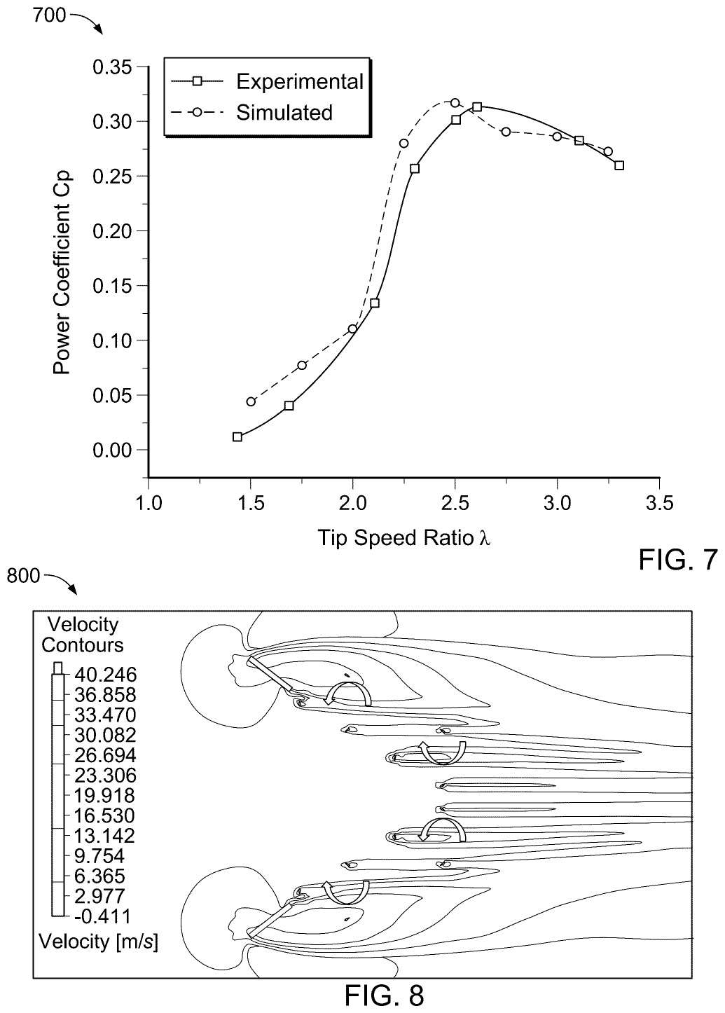

Referring to FIG. 7, using the simulation results, the power coefficients Cₚ for different tip speed ratios TSR (λ) are compared to experimental results in plot 700. The simulation results aligned closely with the experimental data, showing a maximum deviation of 0.04 in the power coefficients.

FIG. 8 depicts a velocity contour plot 800 for wind as it moves to the arrangement of turbines and diffusers. In this example, the velocity for turbines T1 and T4 is greater than those of turbines T2 and T3.

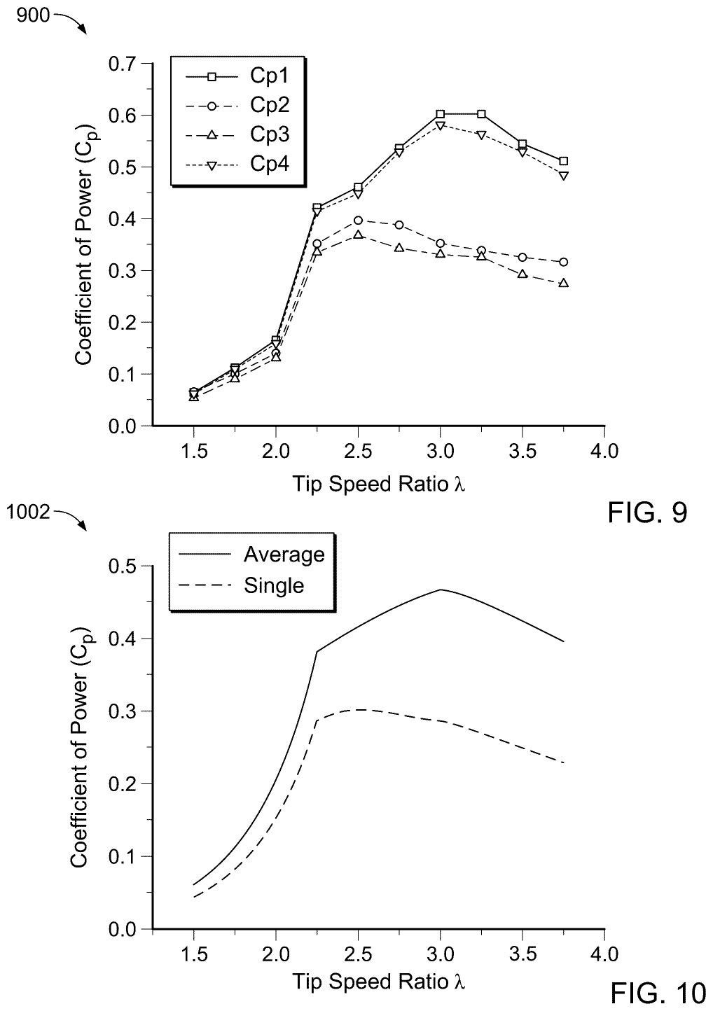

FIG. 9 is a plot 900 of the coefficients of power for the four turbines as a function of the tip speed ratio. In this example, the following equations are used to calculate the coefficients of power for individual turbines:

$$\begin{matrix}{C}_{ms} = \frac{{T}_{s}}{0.5 ρ {V}_{∞}^{2} {RA}_{S}} \\ {C}_{pm} = {C}_{mS} > λ\end{matrix}$$

Cₘₛ is the torque coefficient for turbine m (m being a positive integer), T_{S} is the torque experience at speed S, ρ is the density of air, V_{∝} is the wind speed, R is the radius of the rotor, and A_{S} is the swept area of the wind turbine.

Turbines T1 and T4 have greater coefficients of power Cₚ₁ and Cₚ₄ than turbines T2 and T3 since turbines T1 and T4 are located next to the diffusers D1 and D2. In this example of a simulation, the combined performance of turbines T1 and T2 is superior to the combined performance of turbines T3 and T4 because turbines T1 mitigate some of the negative torque due to chaotic airflow affecting turbines T2.

FIG. 10 is a plot 1002 the coefficient of power versus the tip to speed ratio for the arrangement of turbines and a single turbine. For every value of the tip to speed ratio, the arrangement of turbines outperforms the single turbine, suggesting the performance is enhanced using the described arrangement. Notably, the coefficient of power peaks at 0.47 at a tip to speed ratio of 3.

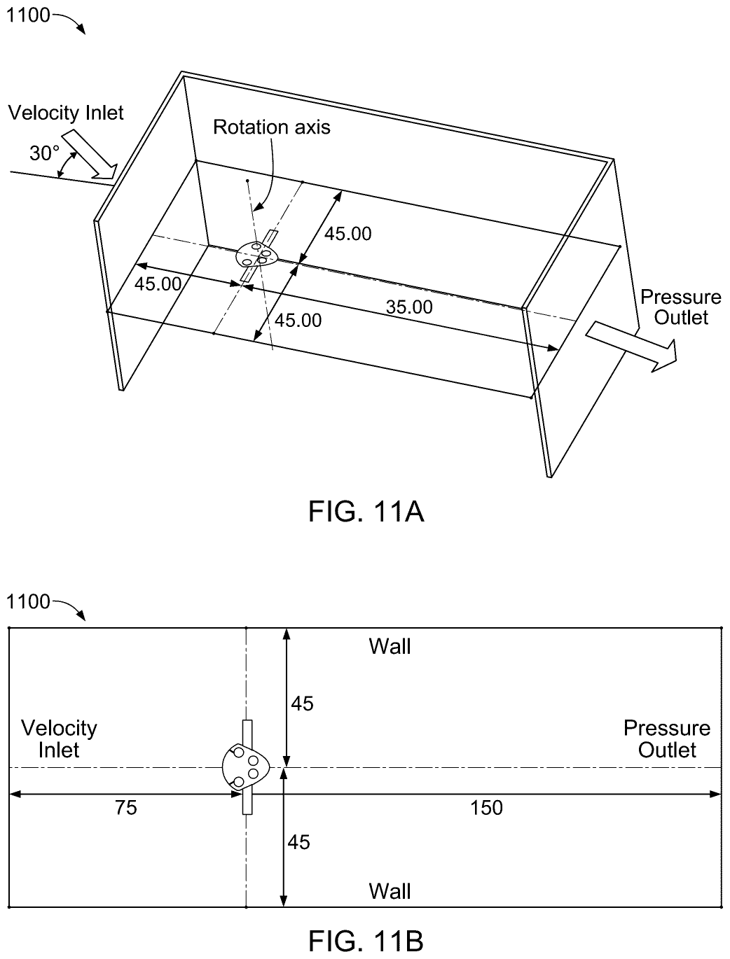

The shape of the exterior of the energy-converting apparatus, e.g., LTA shell 1012, can impact how rapidly the energy-converting apparatus can adjust to win disturbances. FIGS. 11A and 11B respectively depict perspective and plan views of a computational domain set up 1100 for dynamic stability analysis to study the energy-converting apparatus' robustness against abrupt changes in wind direction. The set up 1100 includes a velocity inlet 1102, a pressure outlet 1104, and a rotational axis 1106 of an energy-converting apparatus 1108. In this example, incoming wind is angled at 30° relative to the horizontal direction, e.g., a line connecting the velocity inlet to the pressure outlet. The distance between the velocity inlet and the rotational axis is 75 meters, And the distance between the rotational axis and the pressure outlet is 150. On either side of the energy-converting apparatus 1108, there is a distance of 45 between the rotational axis and a wall.

The computational domain for the stability analysis included 2,079,065 cells. A non-conformal mesh with unstructured quadrilateral elements was employed, akin to the mesh settings used in the VAWT cluster simulations. The geometry did not include a bridle system or generators. In the calculation, it was assumed that each component was a no slip wall with zero deformation. The y+ around the Energy Unit surfaces was between 1 and 5.

The simulation employed fluent code to solve the unsteady Reynolds-Averaged Navier-Stokes (RANS) equations using the finite volume method, consistent with the VAWT cluster simulation. The Semi-Implicit Method for Pressure-Linked Equations (SIMPLE) algorithm was utilized with a second-order spatial discretization for all pressure, momentum, and turbulence equations. Gradients were calculated using the Least Squares Cell-Based algorithm. The Shear-Stress Transport k-ω (SST k-ω) turbulence model was adopted for capturing the turbulence characteristics accurately as the Reynolds number was quite high.

The stability of the system was evaluated using a 6 Degrees-of-Freedom simulation method with one axis rotation enabled. The results characterized the system's dynamic stability against abrupt changes in wind direction, for example with respect to a a sudden 30-degree shift as shown in FIG. 11A. Initially, a steady-state simulation was conducted to establish baseline flow domain parameters. This simulation was followed by transient simulations incorporating the full 6 Degrees of Freedom (DOF) model to capture the unsteady dynamics. Convergence criteria for the transient simulation were defined as a residual drop of at least three orders of magnitude, with a minimum of 20 iterations performed per time step. The simulation utilized a time step of 0.01 seconds and was run for a total of 2500 time steps.

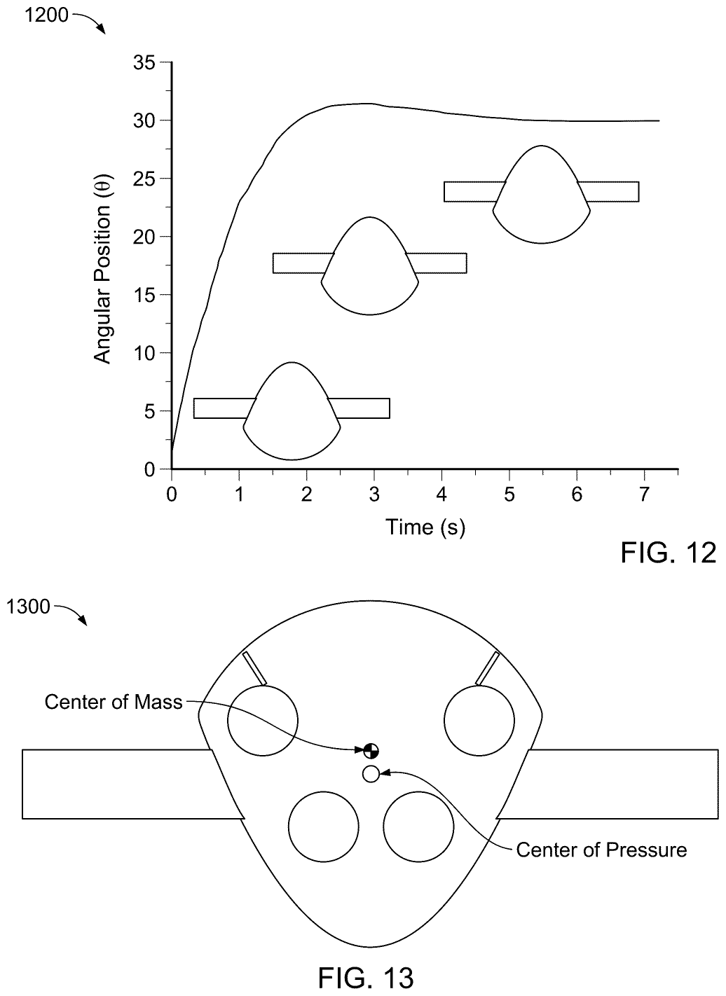

FIG. 12 depicts a plot 1200 capturing the rate at which an energy-converting apparatus re-orients itself to a new incoming wind direction. After 7.2 seconds, the energy-converting apparatus has adjusted relative to the incoming wind. Note that the energy-converting apparatus can overcorrect, e.g., when the angular position is greater than 30°, before reaching a final orientation. This rate of reorientation is relatively fast for AWEs, highlighting advantage of the apparatuses resilience and adaptability to sudden wind changes, which is vital for maintaining consistent energy generation and overall safety.

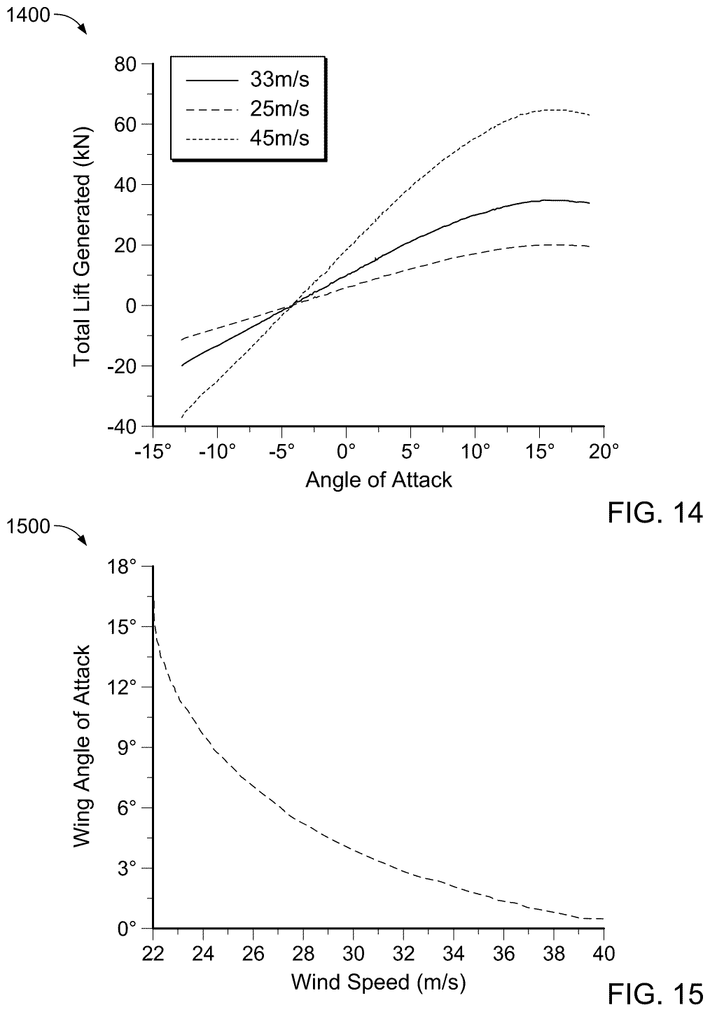

One design feature of the energy-converting apparatus is the location of the center of pressure relative to the center of mass. FIG. 13 depicts an energy-converting device 1300 with the center of pressure directly below the center of mass, e.g., the centers of mass and pressure are not coincident. Both the center of pressure and the center of mass are on a line of symmetry horizontal to the vertical axis. The resultant of aerodynamic forces on the center of pressure. When the center of pressure is below the center of mass, small yaw or pitch motions produce aerodynamic forces that tend to restore the AWE to its initial orientation. With this spatial arrangement, the energy-converting apparatus can be dynamically stable, allowing the apparatus to self-correct and adjust to changes in wind direction.

The energy-converting apparatus can utilize both aerostatic and aerodynamic lift mechanism, offering both stability and operational flexibility. FIG. 14 depicts a plot 1400 of the lift force as a function of angle of attack, e.g., the angle at which a cord of the lift wing meets relative wind. Plot 1400 includes three curves 1402, 1404, and 1406 for wind with speeds of 33 m/s, 25 m/s, and 45 m/s, respectively. The energy-converting apparatus has the ability to change the angle of attack, so the energy-converting apparatus can cause different amounts of lift force to be applied to reach various altitudes.

In some implementations, maintaining a constant lift force allows for stable operation. To maintain a constant lift force, the system can control the lift weightings to dynamically adjust the angle of attack as a function of wind speed. For example, FIG. 15 is a plot 1500 demonstrating that the wing angle of attack is a function of wind speed that results in a constant lift force of 16,250 N. In some implementations, the system can adapt to low wind speeds, e.g., less than 22 m/s, by utilizing crosswind operation to increase the relative wind speed.

### Example 2

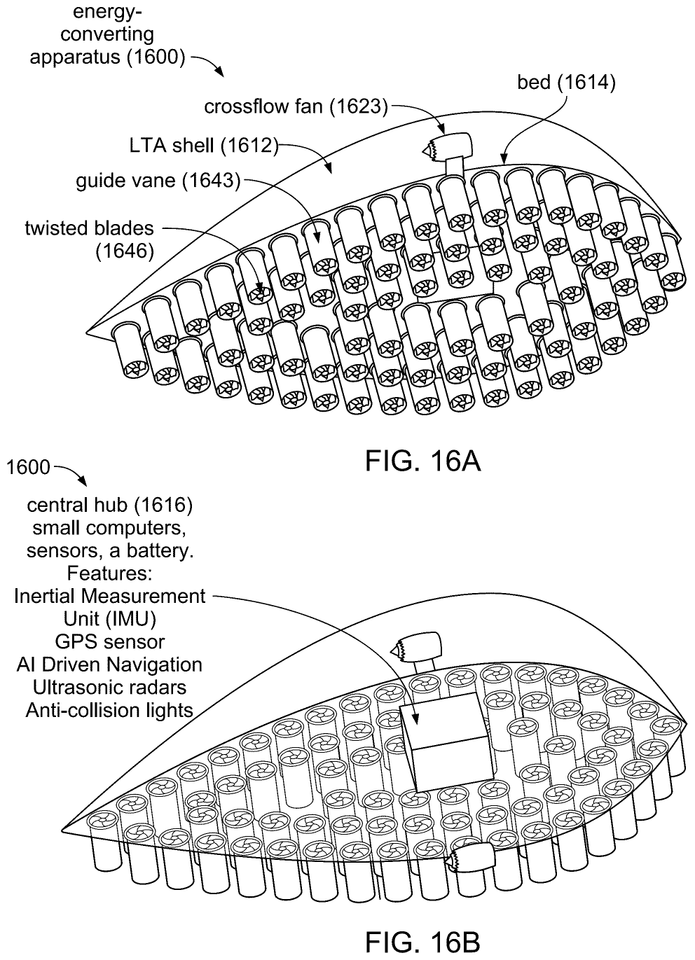

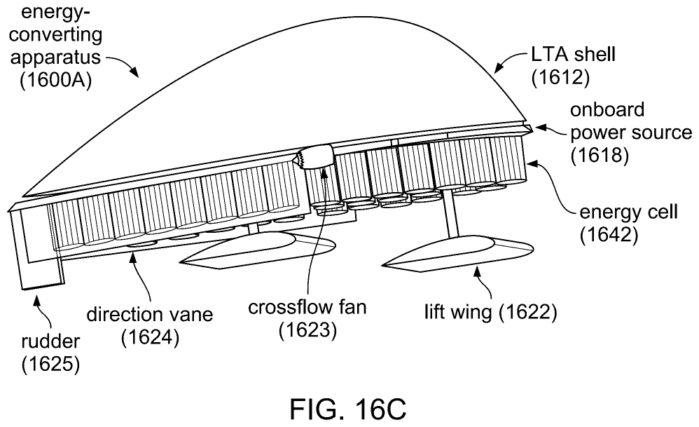

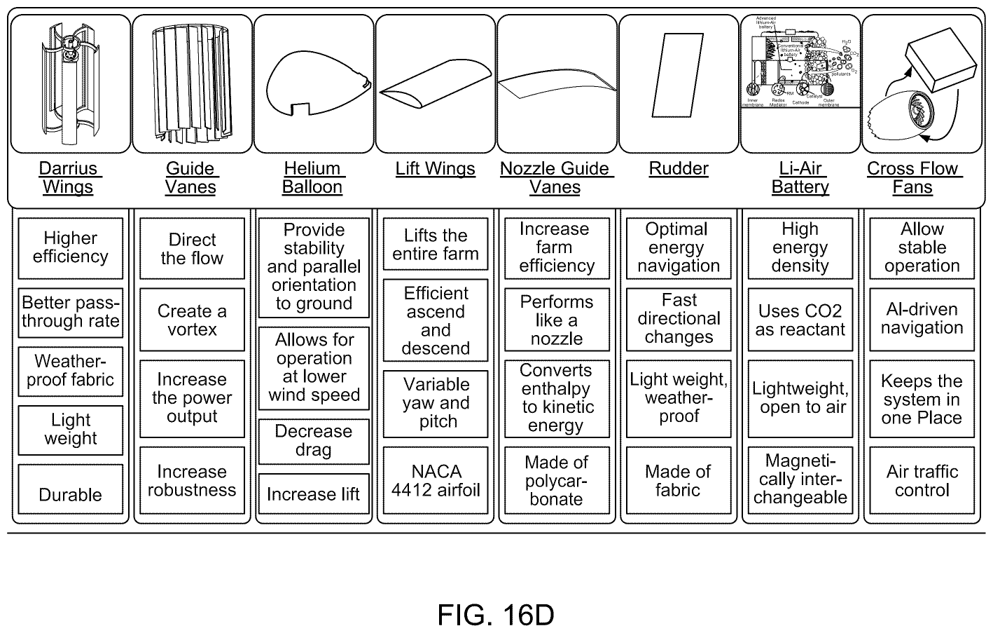

FIG. 16A depicts a view of the bottom of an energy-converting apparatus 1600. The energy-converting apparatus 1600 and LTA shell 1612 with a bed 1614, on which multiple energy cells are disposed. The shape of the bed can be designed to reduce drag and increase system efficiency while distributing airflow evenly throughout the energy cells disposed on the bottom of the bed. For example, the shape of the bed can prevent rotation and maintains orientation, eliminating the need for active orientation correction mechanisms and increasing the likelihood that the energy-converting apparatus faces the wind head-on.

Each turbine of each energy cell includes twisted blades 1646 and is coupled to a respective guide vanes 1643. On each side of the energy-converting apparatus 1600 is a crossflow fan 1623. The crossflow fans 1623 can prevent drift by providing additional forces to maintain the energy-converting apparatus in place. In some implementations, the crossflow fans 1623 consume auxiliary power, though the amount of power consumed can be reduced to near zero value using certain designs, e.g., a blackbird design.

FIG. 16B depicts a view of the top of the energy-converting apparatus 1600, where the LTA shell 1612 is transparent, such that a central hub 1616 located within the LTA shell 1612 is visible. The central hub 1616 can has various components, including sensors, computers, and a battery. In some implementations, the central hub 1616 includes one or more of the following: small computers, sensors, a battery, inertial measurement units, GPS sensors, artificial intelligence driven navigation, ultrasonic radars, and anticollision lights.

For example, the battery can be the main power source during the liftoff phase and can be charged using the converted energy while the energy-converting apparatus is in operation. An inertial measurement unit can be used in conjunction with a GPS sensor to provide detailed information about the location and orientation of the energy-converting apparatus. Ultrasonic radars and anticollision lights the perimeter of the energy-converting apparatus can be in use during operation to promote safe operation.

The computers and/or processors within the central hub 1616 can control the location and altitude of the energy-converting apparatus based on various onboard and radar weather data. The onboard data can be processed through a long-short-memory recurrent neural network, which has been shown to perform well with timeseries data. The processor can then use the results of the neural network to determine instructions that will maximize power generation and satisfy safety precautions.

FIG. 16C depicts a side view of an energy-converting apparatus 1600A. The energy-converting apparatus 1600A includes an LTA shell 1612, on the bottom of which are disposed energy cell 1642. The energy-converting apparatus 1600 a includes lift wings 1622 disposed below the LTA shell 1612. The energy-converting apparatus 1600 includes crossflow fans 1623, a direction vane 1624, e.g., a nozzle guide vane, a rudder 1625, and an onboard power source 1618 (see, e.g., FIG. 16D).

The LTA shell 1612 can have the helium balloon, which provides stability and a parallel orientation to the ground. In some implementations, helium balloons can be ideal for operation at lower wind speeds, can decrease drag, and can increase lift.

In this example, the energy cells include Darrieus wings, which can have a relatively high efficiency of converting wind energy to electrical energy. For example, the Darrieus wings can have a relatively high pass-through rate and be composed of a weatherproof, lightweight, and durable fabric. The energy cells also include guide vanes to direct the flow of wind. The guide vanes can create a vortex within the energy-converting apparatus, which increases the power output and the robustness.

The lift wings 1622 can lift the entire energy-converting apparatus 1600A, e.g., ascend or descend. The lift wings 1622 have variable yaw and pitch, allowing for various degrees of freedom. In some implementations, the lift pins are composed of a NACA 4412 airfoil.

The direction vane 1624 can increase the overall efficiency by converting enthalpy to kinetic energy, e.g., extract power from a wind stream at rates exceeding the Betz limit (59.3%), and performs like a nozzle. In some implementations, the direction vane 1624 is made of poly carbonate. The rudder 1625 reduces the amount of energy used to navigate and allows fast directional changes. In some implementations, the rudder is composed of a lightweight, weatherproof fabric.

The onboard power source 1618 can have a high energy density. In some implementations, the onboard power source 1618 is a lithium air battery that uses CO₂ as a reactant and is lightweight, open to air, and magnetically interchangeable.

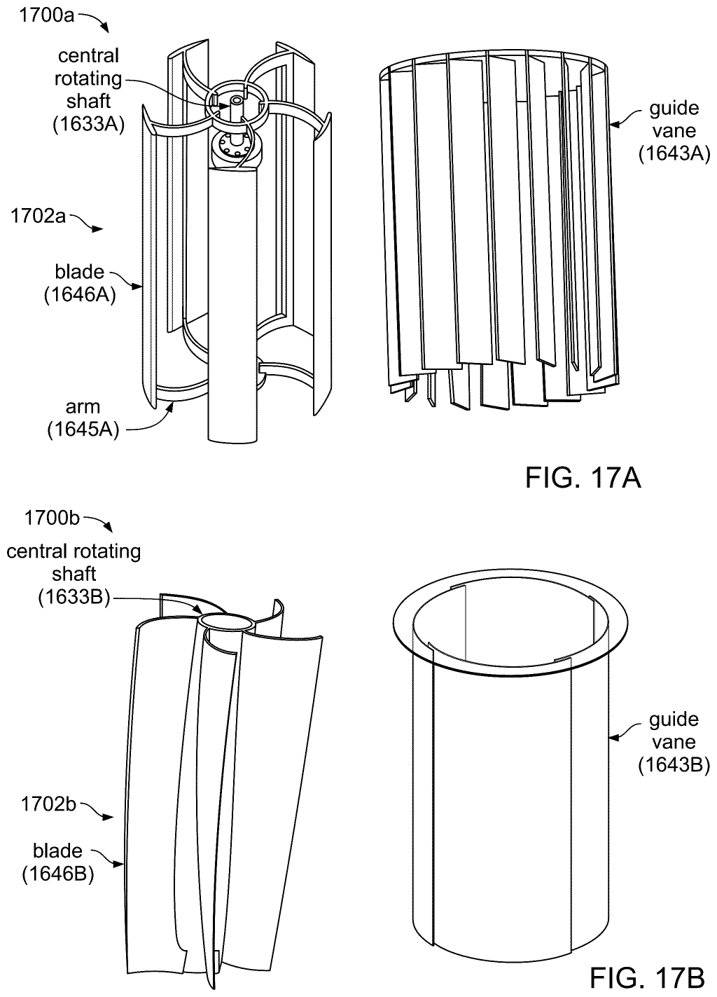

FIGS. 17A and 17B depict two pairs 1700a and 1700b of turbines 1702a and 1702b and guide vanes 1643A and 1643B. The first pair 1700a includes the turbine 1702a and the guide vane 1643A used in the energy-converting apparatus 1600A. The turbine 1702a includes a central rotating shaft 1633A and five blades 1646A connected to the central rotating shaft 1633A by respective arm 1645A. The second pair 1700b includes the turbine 1702b and guide vane 1643B. The turbine 1702b includes a central rotating shaft 1633B and blades 1646B that extend from the central rotating shaft without an interconnecting arm. In some implementations, the first pair 1700a can have a higher efficiency entire pass-through rate compared to the second pair 1700b.

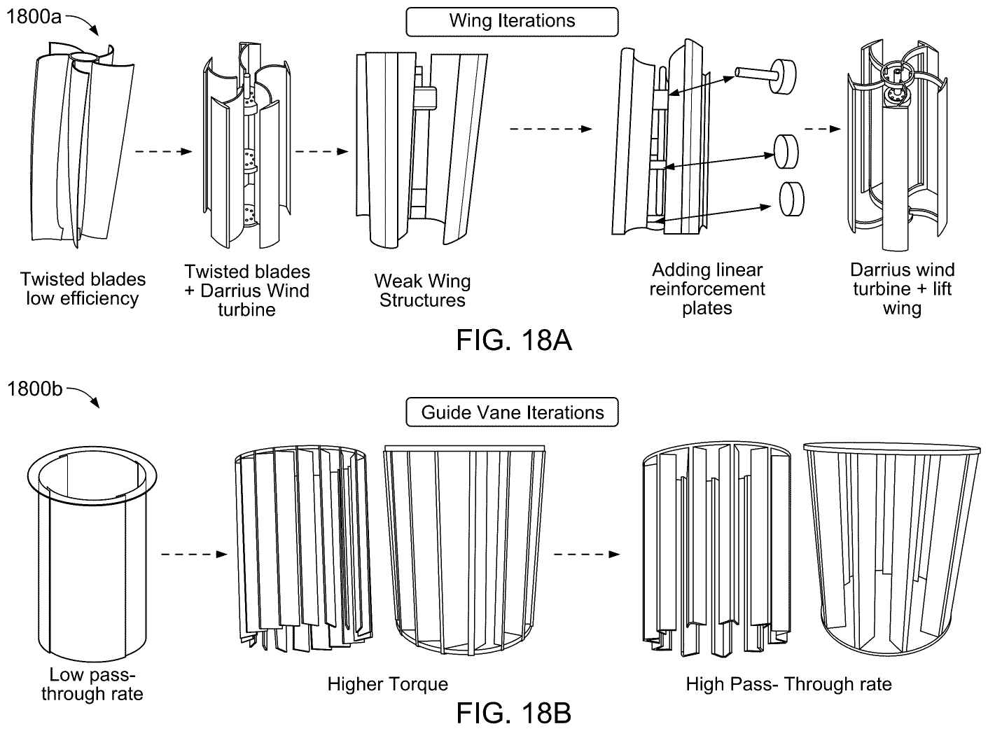

FIGS. 18A and 18B depicts series 1800a and series 1800b of iterations that can improve each of the wings of the turbine and guide vanes. For example, FIG. 18A depict the turbine 1702b, which can be improved by changing the shape of the blades, e.g., wings, to include an angle edge in turbine 1702c. In some implementations, the solid arms can be replaced by a frame, such that the arms define an opening, which can cause weak wings structure, such as in turbine 1702d. Accordingly, linear reinforcement plates 1702 can be added to turbine 1702d, resulting in turbine 1702a.

FIG. 18B depict guide vane 1643B, which has a low pass-through rate. The guide vanes 1643B can be modified to be a pair of components 1643C and 1643D, where component 1643C fits on top of component 1643D, at each of component 1643C and 1643D include columnar features that alternate around the circumference of the guide vane in a circle. The columnar features are angled relative to the radial direction of the circumference, e.g., at a tangent. The tops of components 1643C and 1643D and the bottom of component 1643D are solid circles, and there is no bottom of component 1643C. This arrangement of the columnar features results in a relatively high torque, so the guide vane can be further modified to components 1643E and 1643F. In components 1643E and 1643F, the columnar components are aligned parallel to the radial direction of the circumference of the guide vane, which results in a higher pass-through rate.

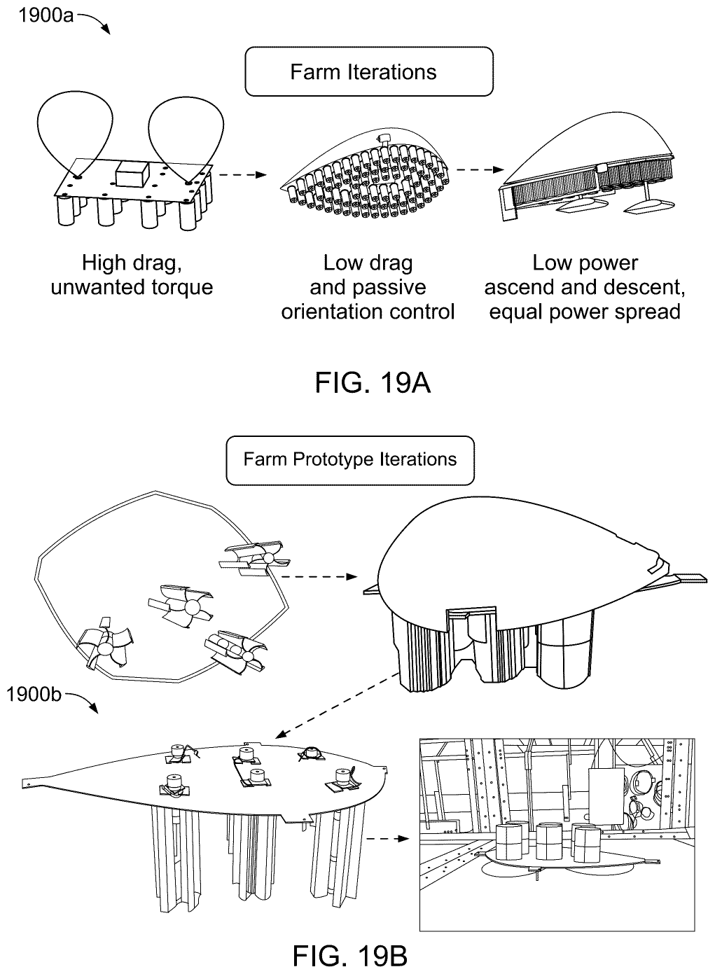

FIG. 19A depicts a series 1900a of iterations that can improve the organization of an AWE farm. For example, farm 1902 includes a rectangular bed with energy cells arranged in a rectangular grid on the bed, with two balloons on either side of the bed. This arrangement, however, leads to high drag and unwanted torque. Farm 1904 includes a tear-drop shaped bed with energy cells arranged on the bottom of the bed with concentric, tear-drop shaped rings. Instead of a flat bed attached to balloons, the farm includes a shell that houses a balloon with a density lower than that of air. The farm 1904 also includes cross control fans. The overall arrangement of farm 1904 results in less drag than that in farm 1902 and features passive orientation control, e.g., self-correction. Farm 1906 further includes direction vanes, rudders, and lift wings that extend below the energy cells. FIG. 19B depicts a series 1900b of iterations on the architecture of an AWE farm.

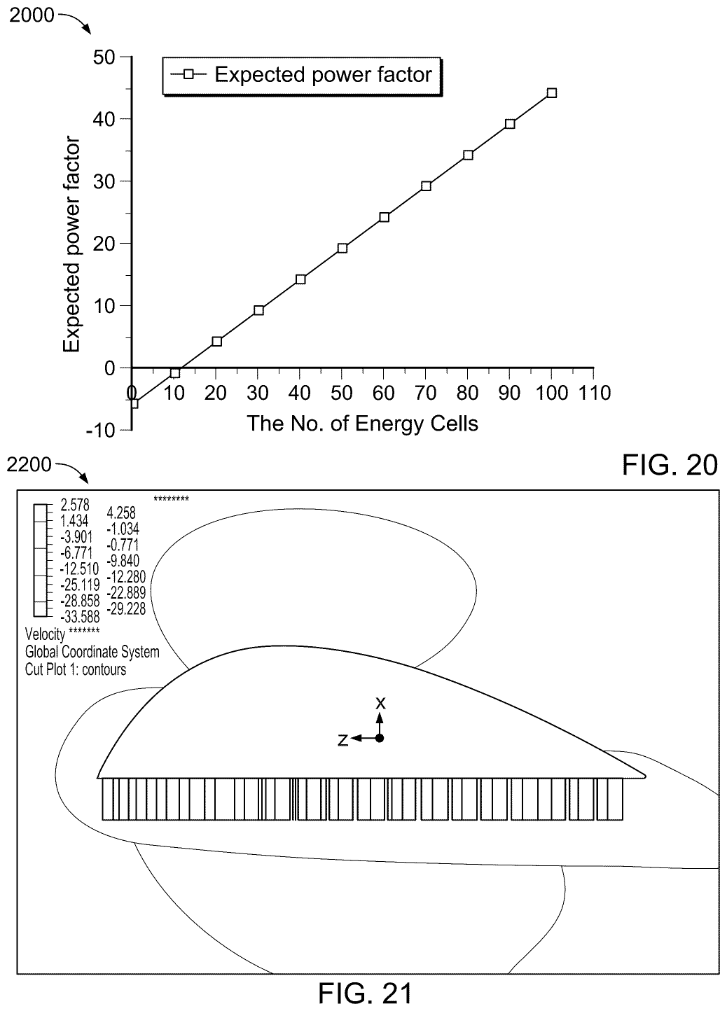

The power factor partially determines the efficiency of an energy system and depends on the number of energy cells and the operating wind speeds and air density. FIG. 20 depicts a plot 2000 of the power factor versus the number of energy cells. The x intercept exceeding zero indicates that the energy system is effectively generating power, and in some implementation, a net positive power output is achieved with as few as 11 energy cells.

FIG. 21 depicts an AWE 2200 with a streamlined balloon shape overlaid on a contour plot 2202 of the wind velocity around the AWE 2200. The streamlined balloon shape is reminiscent of aerodynamic biological shapes, e.g., has an airfoil-like shape and a reduction in unwanted rotation and toppling. In this example, the total volume of this system is 153.93 m³. The coefficient of drag for the entire system can be as low as 0.18. The drift force on the AWE 2200 can be 1107 Newtons, and the effective auxiliary power can be 30 kW (10% of the total power produced). The auxiliary power can power onboard devices, e.g., crossflow fans, drone, balloon, etc. This leaves 90% of the produced power, e.g., 270 kW, to be usable. This VAWT design is scalable to produce megawatts of power.

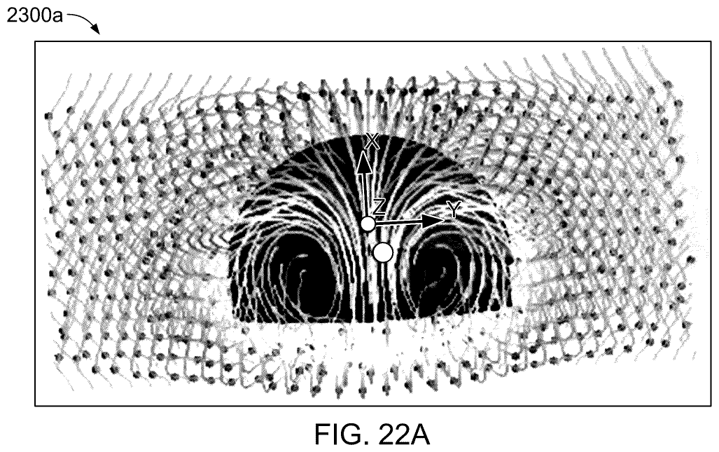

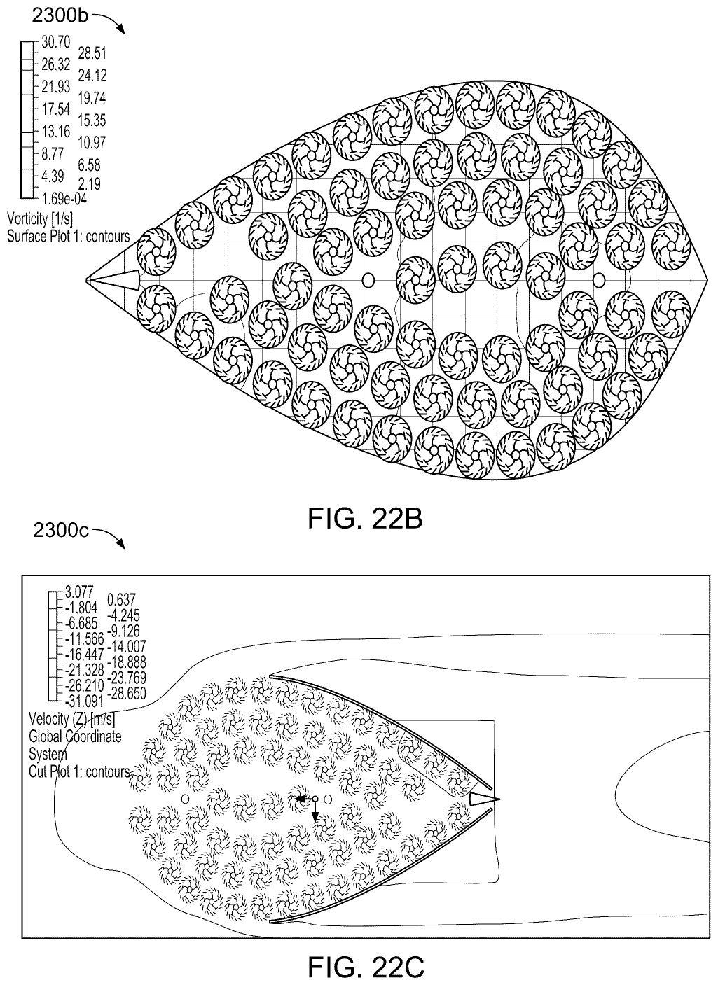

FIG. 22A depicts a plot 2300a of flow trajectories of air particles through the farm. The vectors representing the flow trajectory are most curved in the center of the bed of the AWE, forming a vortex, and generally reduce outward.

FIGS. 22B and 22C depict contour plots 2300b and 2300c of flow trajectories through an AWE farm. Both AWE farms in this example have a tear drop shape, where the wider side of the shape has a pointed tip. In contour plot 2300b, the airflow is greatest near the widest portion of the bed and least near the narrower side of the bed. The air flow speed ranges from 2-30 m/s in most of the bed. In contour plot 2300c, within the AWE, the airflow speed corresponds more to a gradient, e.g., the airflow is greatest at the wider portion of the bed and least at the narrower portion. Outside of the AWE, the air flow is faster at the wider portion of the bed and slower proximate to the narrow portion of the bed.

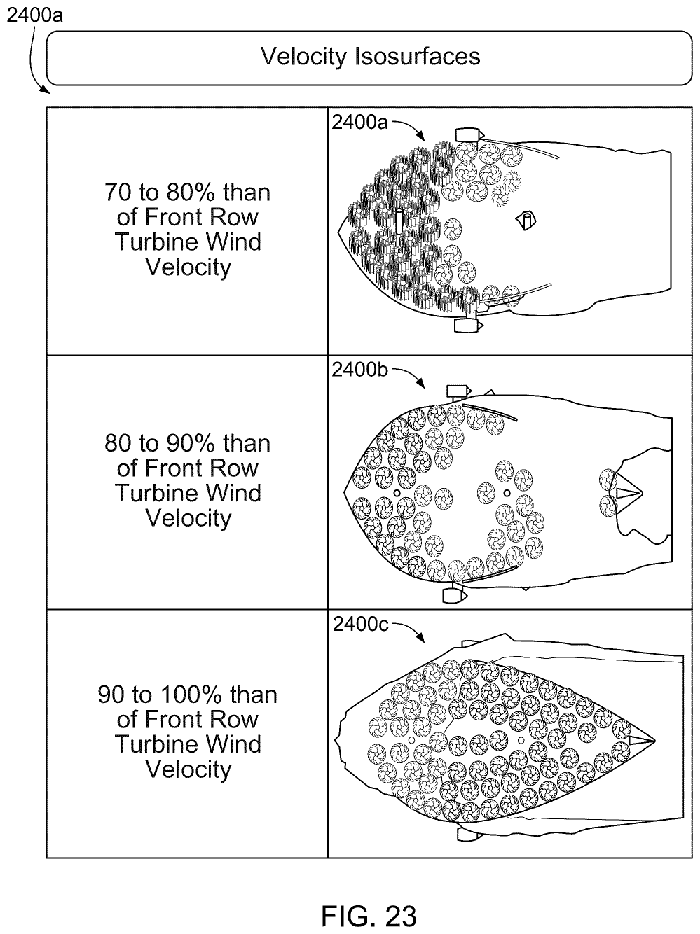

In some implementations, there are velocity isosurfaces within the AWE, e.g., continuous three-dimensional surfaces where the velocity is the same. FIG. 23 depicts an isosurface 2400a, where more than 70-80% of the wind turbines are within a velocity isosurface, an isosurface 2400b, where more than 80-90% of the wind turbines are within a velocity isosurface, and an isosurface 2400c, where more up to 100% of the wind turbines are within a velocity isosurface.

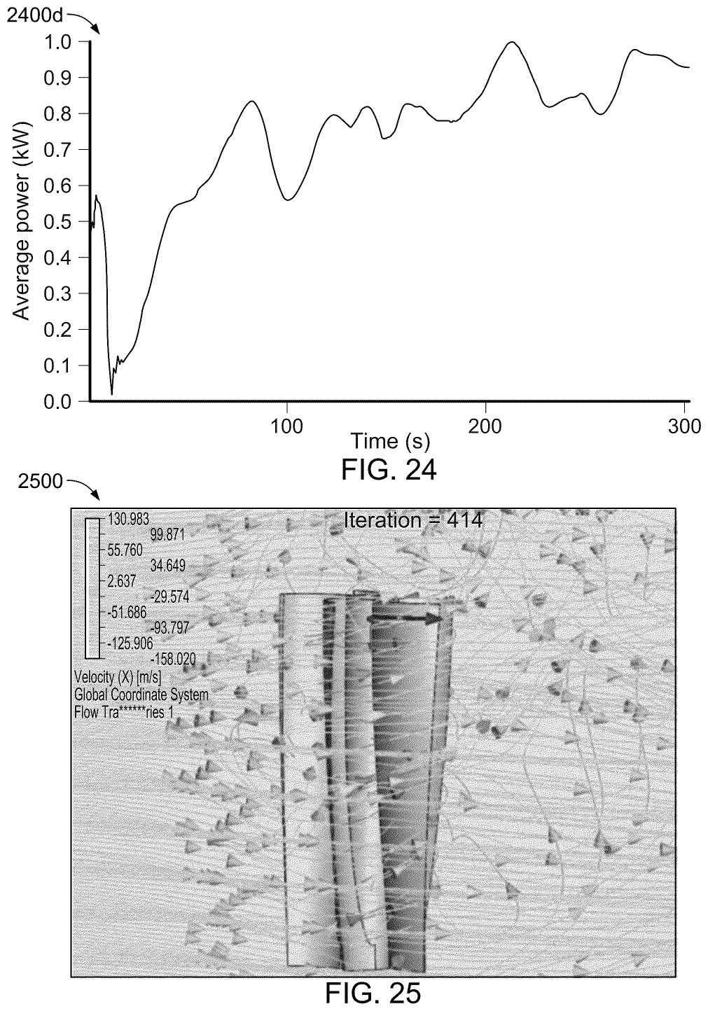

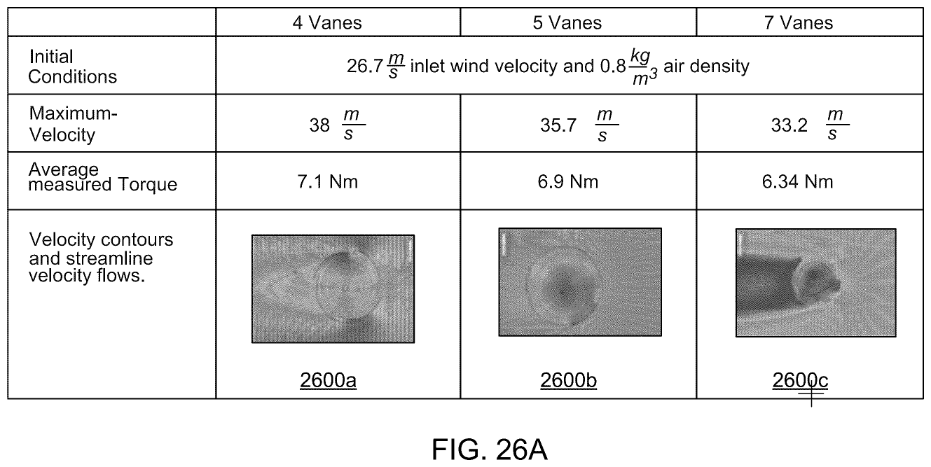

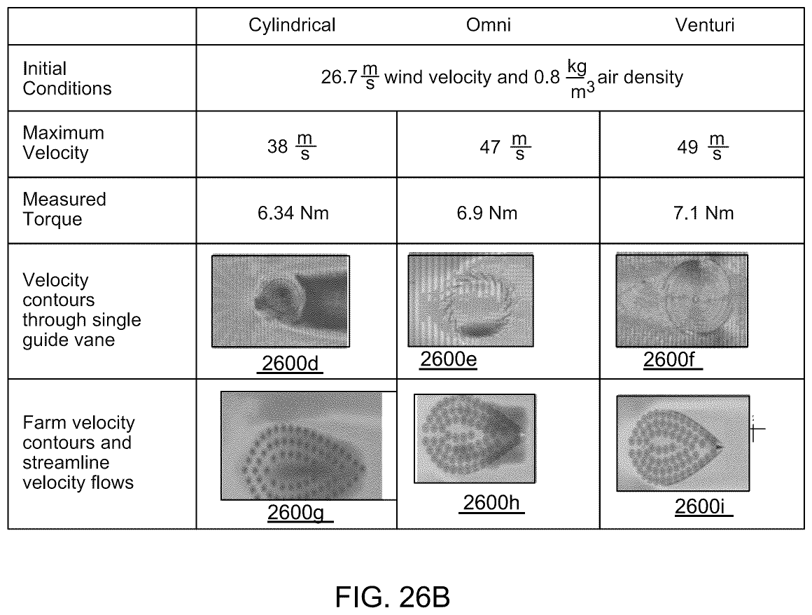

FIG. 24 depicts a plot 2400d of the average power with respect to time (normalized scale) from a single “Energy Cell” unit. A single AWE can utilize 20-100 of such units. There is an initial dip in plot 2400d in power as air from the inlet velocity starts flowing in. After the initial dip, the power output is generally stable. FIG. 25 depicts the flow trajectories of the lift blade.

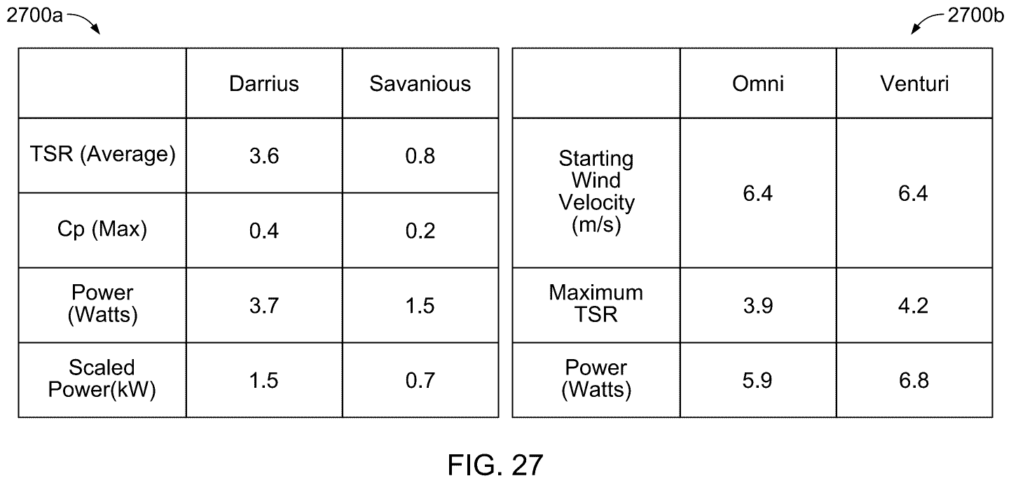

FIG. 26A depicts design parameters of guide vanes with different numbers of guide vanes. For example, the maximum velocity for 4 vanes is 38 m/s, the maximum velocity for 5 vanes is 35.7 m/s, and the maximum velocity for 7 vanes is 33.2 m/s. The average measured torque for 4 vanes is 7.1 Nm, the average measured torque for 5 vanes is 6.9 Nm, and the average measured torque for 7 vanes is 6.34 Nm. All of the guide vanes had the same initial conditions of an inlet wind velocity 26.7 m/s and an air density of 0.8 kg/m³. Each of the guide vanes with different numbers of guide vanes have different velocity contour plots/streamline velocity flows 2600a, 2600b, and 2600c.

FIG. 26B depicts geometrical design parameters of guide vanes. For example, the maximum velocity for a cylindrical guide vane is 38 m/s, the maximum velocity for a first guide vane with omnidirectionality is 47 m/s, and the maximum velocity for the a second guide vane experiencing the Venturi effect is 49 m/s. The average measured torque for cylindrical guide vane is 7.1 Nm, the average measured torque for the Omni guide vane is 6.9 Nm, and the average measured torque for the Venturi guide cane is 7.1 Nm. All of the guide vanes had the same initial conditions of an inlet wind velocity 26.7 m/s and an air density of 0.8 kg/m³. Each of the guide vanes with different geometries have different velocity contour plots, e.g., contour plots through single guide vane 2600d, 2600e, and 2600f and contour plots through an entire AWE farm 2600g, 2600h, and 2600i.

FIG. 27 depicts a tables 2700a and 2700b with parameters from testing wind tunnels for different geometries. Table 2700a depicts various parameters for the Darrieus and Savanious blades. For example, for the Darrieus blades, the average TSR is 3.6, the maximum power coefficient Cₚ is 0.4, the power is 3.7 Watts, and the scaled power is 1.5 kW. For the Savanious blades, the average TSR is 0.8, the maximum power coefficient Cₚ is 0.2, the power is 1.5 Watts, and the scaled power is 0.7 kW. For the Omni AWE, the starting wind velocity is 6.4 m/s, the maximum TSR is 3.9, and the power is 5.9 Watts. For the Venturi AWE, the starting wind velocity is 6.4 m/s, the maximum TSR is 4.2, and the power is 6.8 Watts.

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. An airborne wind-driven energy-converting apparatus comprising:
a flotation module comprising a lighter-than-air (LTA) shell configured to provide an inner volume and a bed region disposed beneath the LTA shell;
a stability module configured to control drift and elevation of the apparatus, wherein the stability module is disposed on a surface of the flotation module;
an energy module comprising a plurality of energy cells, wherein at least one energy cell comprises an angled axis wind turbine;
a tethered power transfer module connected to an energy storage unit; and
a ground control module equipped with sensors.

2. The apparatus of claim 1, wherein the LTA shell comprises a hydrophobic material disposed on an inner surface of the shell and a composite material and a shape memory alloy disposed on an outer surface of the shell, and
wherein the inner volume of the LTA shell comprises a lighter-than air gas.

3. The apparatus of claim 1, further comprising one or more components selected from the group consisting of a heater, a processor, an inertial measure unit, a navigation system, a positioning system, a control system, a sensor, a power source, a radar, and an anticollision system.

4. The apparatus of claim 1, further comprising a heater disposed within an internal volume of the LTA shell, and wherein the heater is configured to heat a gas within the internal volume,
wherein the heater is configured to transmit and receive information from one or more of a processor, a inertial measure unit, a navigation system, a positioning system, a control hub, a sensor, a power source, or a radar.

5. The apparatus of claim 1, wherein the LTA shell comprises shape memory alloys configured to cause the LTA shell to expand or contract based on a temperature gradient of an atmosphere surrounding the airborne wind-driven energy-converting apparatus.

6. The apparatus of claim 1, wherein the stability module comprises one or more components configured to control the drift and the elevation.

7. The apparatus of claim 6, wherein the one or more components is selected from the group consisting of a lift wing, a bridle, a tether, a fan, a direction vane, and a rudder.

8. The apparatus of claim 6, wherein at least one component comprises a lift wing on a surface of the LTA shell or a surface of the bed region, a bridle, and a tether.

9. The apparatus of claim 1, wherein the angled axis wind turbine comprises a central rotating shaft, and wherein each of a plurality of blades is attached to the central rotating shaft by a respective arm; or wherein the angled axis wind turbine comprises a frame including a central rotating shaft connected to each of a plurality of blades by a respective arm.

10. The apparatus of claim 9, wherein the angled axis wind turbine comprises a plurality of blades extending from the central rotating shaft.

11. The apparatus of claim 1, wherein a pair of energy cells of the plurality of energy cells comprises a pair of counter rotating energy cells.

12. The apparatus of claim 1, wherein the at least one energy cell comprises a wall or guide vane configured to direct and block air to the angled axis wind turbine.

13. The apparatus of claim 1, wherein the energy module further comprises one or more generators configured to rotate the plurality of energy cells.

14. The apparatus of claim 1, wherein an axis of the angled axis wind turbine is a vertical axis.

15. A wind-driven energy system comprising:
one or more airborne wind-driven energy-producing apparatuses of claim 1; and
a ground station configured to communicate with and form a tether with at least one of the one or more airborne wind-driven energy-producing apparatuses.

16. The system of claim 15, wherein the tether is configured to transmit and receive power or energy between the at least one airborne wind-driven energy-producing apparatus.

17. The system of claim 15, wherein the tether is configured to transmit and receive information between the at least one airborne wind-driven energy-producing apparatus.

18. The system of any claim 15, wherein the ground station comprises a motor configured to extend and retract the tether between the ground station and the at least one airborne wind-driven energy-producing apparatus.

19. The system of claim 15, wherein the ground station comprises an energy storage unit.

20. The system of any claim 15, wherein the ground station comprises one or more of the following: a processor, a power meter, a communication system, a weather station, GPS, a load cell, a tension sensor, an accelerometer, and a gyroscope.
